(19) United States
(12) Patent Application Publication
(10) Pub. No.: US 2008/0207837 A1
(43) Pub. Date: Aug. 28, 2008

(54) Method for Producing Polymer Powders

(75) Inventors: Axel Weiss, Speyer (DE); Marc Bothe, Limburgerhof (DE); Rainer Nolte, Limburgerhof (DE); Matthias Klausmann, Ludwigshafen (DE); Patrick Amrhein, Hochheim (DE); Kenneth Landherr, Ludwigshafen (DE); Gerald Wildburg, Speyer (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 11/817,290

(22) PCT Filed: Mar. 20, 2006
(86) PCT No.: PCT/EP06/60889

§ 371 Date: Aug. 28, 2007

(30) Foreign Application Priority Data
Mar. 21, 2005 (DE) 10-2005013-439.9

(51) Int. Cl. C08F 279/02

(52) U.S. Cl. 525/243

(57) ABSTRACT

The present invention relates to the production of a polymer powder with improved powder properties, and to its use as impact modifier for rigid polyvinyl chloride (PVC) applications. The impact modifier is composed of emulsion polymer particles which have a core-shell structure, where the shell is composed of a hard polymer and the core is composed of a soft, crosslinked rubber polymer.

The present invention relates to the production of a polymer powder with improved powder properties, and to its use as impact modifier for rigid polyvinyl chloride (PVC) applications. The impact modifier is composed of emulsion polymer particles which have a core-shell structure, where the shell is composed of a hard polymer and the core is composed of a soft, crosslinked rubber polymer.

Impact modifiers of this type are usually produced via a multistage free-radical emulsion polymerization process.

The resultant modifier dispersion is converted into powder form via spray drying or via precipitation and subsequent drying of the coagulate, and is mixed with pulverulent PVC and, if appropriate, with conventional additives.

The principle of impact modification is based on embedding a finely dispersed phase of a soft, elastic polymer into the continuous PVC phase. This “rubber phase” permits better dissipation of energy on impact.

As the proportion by weight of the core in the impact modifier particles increases, higher impact-resistance efficiency is achieved. EP 1 201 701 and EP 1 111 001 disclose that the proportion of the soft phase of an impact modifier should be maximized in order to maximize impact resistance.

It is known that the resultant powder properties become less favorable as the content of soft-phase core rises in the polymer particles to be dried. If the content of the hard shell polymer is very small, this shell becomes incomplete, and a correspondingly high content of the soft core polymer therefore makes the dried polymer very tacky. The tack severely impairs the properties of the powder, and the flowability of the powder is reduced.

U.S. Pat. No. 4,278,576 teaches that addition of a hydrophobically coated, precipitated calcium carbonate powder as flowability aid prior to or during the drying of an impact modifier polymer dispersion with a high proportion of core by weight improves the properties of the resultant powder.

It was an object of the present invention to improve the properties of an impact modifier powder with a high proportion of core by weight and with high impact-resistance efficiency.

The invention achieves the object via

a process for production of polymer powder from an aqueous polymer dispersion, which comprises obtaining the aqueous dispersion of the polymer particles II via free-radical-initiated aqueous emulsion polymerization of at least one ethylenically unsaturated monomer C in the presence of dispersely distributed polymer particles I, where
a) the polymer of the at least one unsaturated monomer C has a glass transition temperature >60° C.,
b) the dispersely distributed polymer particles I are obtained via free-radical-initiated aqueous emulsion polymerization of a monomer mixture I, composed of

| | |
|---|---|
| from 98.0 to 99.9% by weight | of at least one ethylenically unsaturated |
| | monomer A whose polymer has a glass |
| | transition temperature <−20° C., and |
| from 0.1 to 2.0% by weight | of at least one compound (monomer B) |
| | having crosslinking action and having at |
| | least two non-conjugated vinyl groups, |

c) the quantitative ratio of monomer mixture I to monomer C is >90% by weight: <10% by weight, where the total amounts of monomer mixture I and monomer C give a total of 100% by weight,
d) the powder is produced from the aqueous dispersion of polymer particles II
   i. via spray drying in the presence of from 0.1 to 15% by weight of at least one antiblocking agent, based on the total weight of polymer particles II, and subsequent comminution of the crude powder by means of mechanically and/or pneumatically induced shear forces, or
   ii. via mechanical and/or pneumatic grinder drying in the presence of from 0.1 to 15% by weight of at least one antiblocking agent, based on the total amount of polymer particles II.

It has been found that the powder properties of an impact modifier polymer powder produced via spray drying in the presence of from 0.1 to 15% by weight of an antiblocking agent are markedly improved via subsequent shear via mechanically and/or pneumatically induced shear forces.

When compared with the crude powder, the powder thus treated exhibits improved flowability, higher bulk density, and less tendency to caking on storage under load.

The invention also provides PVC compositions comprising the polymer powder produced by the inventive process, and provides moldings produced using the resultant PVC compositions.

The average particle diameter of the polymer particles II is in the range from 100 to 500 nm, preferably from 220 to 320 nm.

The graft copolymers of the inventive chemical constitution are known per se.

The core of the particles is composed of a crosslinked emulsion polymer (polymer I) with a glass transition temperature <−20° C. The shell is composed of a polymer of the at least one monomer C, this being compatible with PVC and having a glass transition temperature >60° C.

The content of the graft shell is from 10 to 0.1% by weight, preferably from 7 to 3% by weight. It comprises from 90 to 100% by weight of the ethylenically unsaturated monomer C. Examples of the monomer C are C₁-C₄-alkyl methacrylates, C₁-C₈-alkyl acrylates, vinyl chloride, styrene, or acrylonitrile, or mixtures of these. The monomer C used particularly preferably comprises methyl methacrylate. Alongside this, other copolymerizable ethylenically unsaturated monomers may also be added to the monomers C, where the total amounts of monomer C and of the ethylenically unsaturated monomer give a total of 100% by weight. The polymer of the shell is advantageously compatible with PVC.

The graft copolymers comprise from 90 to 99.9% by weight, preferably from 93 to 97% by weight, of a soft graft core composed of a crosslinked rubber composed of the monomers A and B (polymer I).

By way of example, the monomers A have been selected from the group of the C₁-C₈-alkyl acrylates, preferably butyl acrylate, 2-ethylhexyl acrylate, or from mixtures of these. Alongside these, other copolymerizable ethylenically unsaturated monomers may also be added to the monomers A. The content of monomer A is from 95 to 100% by weight, where the total amounts of monomer A and of the ethylenically unsaturated monomer give a total of 100% by weight.

The monomers B act as crosslinking agents and their amounts used are from 0.1 to 2.0% by weight. The monomers B are compounds having crosslinking action and having at least two non-conjugated vinyl groups, examples being allyl methacrylate, butanediol methacrylate, or dihydrodicyclopentadienyl acrylate.

The ratio by weight of the polymer I to monomer C is more than 90% by weight to less than 10% by weight, preferably more than 93% by weight to less than 7% by weight, particularly preferably more than or equal to 97% by weight to less than or equal to 3% by weight, where the total amounts give a total of 100% by weight. It has been found that impact-resistance efficiency passes through an optimum in the inventive range.

The graft polymers are usually prepared via emulsion polymerization in two stages, first polymerizing the monomers A+B to give the crosslinked polyacrylate rubber, and then, in its presence, polymerizing the monomers C. The initiators used may comprise water-soluble thermally decomposing initiators or redox systems. Examples of suitable thermally decomposing initiators are sodium peroxodisulfate, potassium peroxodisulfate, or ammonium peroxodisulfate. Examples of redox systems which may be used are hydroperoxides in combination with reducing agents. The emulsion polymerization process may use conventional emulsifiers, such as: alkyl, aryl, alkanyl, C₁₀-C₁₃-alkyl derivatives of benzenesulfonic acid, or the corresponding sulfates, or polyether sulfates, ethoxylated fatty acids, ethoxylated fatty esters, ethoxylated fatty alcohols, ethoxylated fatty amines, ethoxylated fatty amides, ethoxylated fatty-alkylphenols, or organophosphoric acids. The emulsion polymerization process takes place at from 10 to 100° C. It can be conducted either as a batch process or else in the form of a feed process, including a procedure involving stages or gradients. Preference is given to the feed procedure in which one portion of the polymerization mixture is used as initial charge and heated to polymerization temperature, and incipient polymerization is carried out and then the rest of the polymerization mixture is added, usually by way of two or more separate feeds, of which one or more comprise the monomers in pure or emulsified form, continuously, in stages, or with imposition of a concentration gradient while maintaining the polymerization process.

According to the invention, the graft copolymer can have a bi- or multimodal particle size distribution. It can comprise at least two types of graft rubber which have the same chemical constitution but whose average particle diameters differ by at least 30 nm, preferably by at least 50 nm. The content here of the type of graft rubber with the greatest average particle diameter is at least 15%, preferably at least 20% and in particular at least 25%, based on the entire graft copolymer. Its average particle diameter is preferably in the range from 200 to 500 nm, in particular from 250 to 350 nm. The content of the type of graft rubber with the smallest average particle diameter is at least 5%, preferably at least 8%, and in particular at least 12%, based on the entire graft polymer. Its average particle diameter is preferably in the range from 50 to 250 nm, in particular from 80 to 200 nm. Alongside these, other types of graft rubber Y₁, Y₂, Y₃, etc., may be present, their average particle diameters being between those of the types X and Z of graft rubber.

Multimodal particle size distributions can be obtained via various methods: a targeted particle size distribution can even be produced via synthesis parameters during the emulsion polymerization process. It is also possible to mix monomodal dispersions produced via emulsion polymerization after the synthesis process, or to mix appropriate powders after the dispersions have been dried.

Graft rubbers with comparatively narrow, defined particle size distribution are advantageously prepared via the “seed latex” method. The seed latex is the aqueous emulsion of a polymer of the monomers C, preferably a homopolymer of styrene, of methyl methacrylate, of a C₁-C₈-alkyl acrylate, or is a copolymer of these monomers. The average particle diameter of the polymer is preferably from 10 to 50 nm. In this method, the emulsion of the monomers A+B is carried out in the presence of the initial charge of the seed latex, whose solids amount to from 0.01 to 7% by weight, preferably from 0.1 to 5% by weight, of the monomers. The average particle diameter of the graft rubber then depends on the amount of solid used as initial charge: if the amount of solid is high, either the amount of seed latex or its concentration can be used as control factors.

The fine-particle graft copolymer obtained during polymerization of the monomers C in the presence of the polyacrylate rubber composed of the monomers A+B is dried, and amounts of from 1 to 25% by weight of the pulverulent impact modifier are mixed with PVC powder and with conventional additives, e.g. fillers, stabilizers, and processing aids, and are processed by conventional methods to give high-impact-resistance PVC moldings.

Another possibility is that the polymer particles II of the impact modifier are blended, prior to the spray-drying process, with polymer particles III obtained via free-radical-initiated aqueous emulsion polymerization of at least one ethylenically unsaturated monomer D, these having a glass transition temperature >50° C. (monomers D).

Examples of the monomers D are C₁-C₈-alkyl acrylates, C₁-C₄-alkyl methacrylates, styrene, acrylonitrile, methacrylic acid, acrylic acid, or compounds having crosslinking action and having at least two non-conjugated vinyl groups, or mixtures of these. Alongside these, other copolymerizable ethylenically unsaturated monomers may also be added to the monomers D, where the total amounts of monomer D and of the ethylenically unsaturated monomer give a total of 100% by weight.

These polymer particles D preferably have a copolymer constitution which is miscible with PVC. If the polymer particles D added are not crosslinked particles, a preferred copolymer constitution is composed of at least 75% by weight of methyl methacrylate and up to 25% by weight of other C₁-C₈-alkyl acrylates and C₁-C₄-alkyl methacrylates. Another preferred copolymer constitution is composed of at least 65% by weight of styrene and up to 35% by weight of acrylonitrile.

The average particle diameter of the polymer particles III is from 50 to 300 nm, preferably from 70 to 170 nm. The content is greater than 5% by weight and smaller than 30% by weight, based on the amount of polymer particles II.

Examples of the other copolymerizable ethylenically unsaturated monomers which may also be added to the monomers A, C and D are acrylic acid, methacrylic acid, ethylacrylic acid, allylacetic acid, crotonic acid, vinylacetic acid, maleic half-esters, such as monomethyl maleate, their mixtures or their alkali metal and ammonium salts, linear 1-olefins, branched-chain 1-olefins or cyclic olefins, e.g. ethene, propene, butene, isobutene, pentene, cyclopentene, hexene, cyclohexene, octene, 2,4,4-trimethyl-1-pentene, if appropriate mixed with 2,4,4-trimethyl-2-pentene, C₈-C₁₀ olefin, 1-dodecene, C₁₂-C₁₄ olefin, octadecene, 1-eicosene (C₂₀), C₂₀-C₂₄ olefin; oligoolefins prepared via metallocene catalysis and having a terminal double bond, e.g. oligopropene, oligohexene, and oligooctadecene; olefins prepared via cationic polymerization and having high content of α-olefin, e.g. polyisobutene.

Vinyl and allyl alkyl ethers having from 1 to 40 carbon atoms in the alkyl radical, where the alkyl radical can also bear other substituents, such as a hydroxy group, an amino group, or a dialkylamino group, or may bear one or more alkoxylate groups, e.g. methyl vinyl ether, ethyl vinyl ether, propyl vinyl ether, isobutyl vinyl ether, 2-ethylhexyl vinyl ether, vinyl cyclohexyl ether, vinyl 4-hydroxybutyl ether, decyl vinyl ether, dodecyl vinyl ether, octadecyl vinyl ether, 2-(diethylamino)ethyl vinyl ether, 2-(di-n-butylamino)ethyl vinyl ether, methyldiglycol vinyl ether, and also the corresponding allyl ethers and their mixtures.

Acrylamides and alkyl-substituted acrylamides, e.g. acrylamide, methacrylamide, N-tert-butylacrylamide, N-methyl(meth)acrylamide.

Monomers containing sulfo groups, e.g. allylsulfonic acid, methallylsulfonic acid, styrenesulfonate, vinylsulfonic acid, allyloxybenzenesulfonic acid, 2-acrylamido-2-methylpropanesulfonic acid, their corresponding alkali metal or ammonium salts, and mixtures of these.

C₁-C₈-alkyl esters or C₁-C₄-hydroxyalkyl esters of acrylic acid, methacrylic acid, or maleic acid, or esters of C₁-C₁₈ alcohols alkoxylated with from 2 to 50 mol of ethylene oxide, of propylene oxide, of butylene oxide, or of mixtures of these, with acrylic acid, methacrylic acid, or maleic acid, e.g. methyl (meth)acrylate, ethyl (meth)acrylate, propyl (meth)acrylate, isopropyl (meth)acrylate, butyl (meth)acrylate, hexyl (meth)acrylate, 2-ethylhexyl (meth)acrylate, hydroxyethyl (meth)acrylate, hydroxypropyl (meth)acrylate, 1,4-butanediol monoacrylate, dibutyl maleate, ethyldiglycol acrylate, methylpolyglycol acrylate (11 EO), (meth)acrylic esters of C₁₃/C₁₅ oxo alcohol reacted with 3, 5, 7, 10, or 30 mol of ethylene oxide and, respectively, their mixtures.

Alkylaminoalkyl (meth)acrylates or alkylaminoalkyl(meth)acrylamides or their quaternization products, e.g. 2-(N,N-dimethylamino)ethyl (meth)acrylate, 3-(N,N-dimethylamino)propyl (meth)acrylate, 2-(N,N,N-trimethylammonium)ethyl (meth)acrylate chloride, 2-dimethylaminoethyl (meth)acrylamide, 3-dimethylaminopropyl(meth)acrylamide, 3-trimethylammoniumpropyl(meth)acrylamide chloride.

Vinyl and allyl esters of C₁-C₃₀ monocarboxylic acids, e.g. vinyl formate, vinyl acetate, vinyl propionate, vinyl butyrate, vinyl valerate, vinyl 2-ethylhexanoate, vinyl nonanoate, vinyl decanoate, vinyl pivalate, vinyl palmitate, vinyl stearate, vinyl laurate.

Other monomers which may be mentioned are:

N-Vinylformamide, N-vinyl-N-methylformamide, styrene, α-methylstyrene, 3-methylstyrene, butadiene, N-vinylpyrrolidone, N-vinylimidazole, 1-vinyl-2-methylimidazole, 1-vinyl-2-methylimidazoline, N-vinylcaprolactam, acrylonitrile, methacrylonitrile, allyl alcohol, 2-vinylpyridine, 4-vinylpyridine, diallyidimethylammonium chloride, vinylidene chloride, vinyl chloride, acrolein, methacrolein, and vinylcarbazole, and mixtures of these.

Antioxidants may be added to the dispersion prior to the spray-drying process. The form in which the antioxidants are admixed with the polymer dispersion is that of pellets, of pulverulent solid, or preferably of dispersion. Addition of antioxidants is described by way of example in EP 44 159 and EP 751 175. A particular purpose of adding antioxidants is to avoid spontaneous heating and spontaneous ignition of the spray-dried product during storage and transport. Preferred antioxidants are those selected from the substance class of the sterically hindered alkylphenols or of their condensates. Possible antioxidants can be found in Plastics Additives Handbook, 5th ed., Munich 2000, 1-139, Hanser Verlag.

Antiblocking agents are moreover added to the dispersion during the spray-drying process. The amounts added of the antiblocking agent are from 0.1 to 15% by weight, preferably from 3 to 8% by weight. In one preferred embodiment, hydrophobicized antiblocking agents are used. The antiblocking agents are fine-particle powders, for example composed of calcium carbonate, talc, or silicas. Examples of hydrophobicized antiblocking agents are calcium carbonate coated with fatty acids or with fatty alcohols, for example stearic acid or palmitic acid, or silicas chemically modified via surface treatment with reactive silanes, for example with chlorosilanes or with hexamethyldisilazane. It is preferable to use stearic acid-coated calcium carbonate. The primary particle size of the antiblocking agents is preferably smaller than 100 nm.

Any of the mills known to the person skilled in the art for fine milling can be used to apply shear to the powder obtained from the spray-drying process and to comminute the same. These are cutting mills, impact mills, such as rotor-impact mills or jet-impact mills, roller mills, such as rolling mills, roll mills, or grinding rolls, mills comprising grinding materials, e.g. bore mills, rod mills, autogenous mills, planetary mills, vibratory mills, centrifugal mills, or stirrer mills, and also milling driers. Comminution machinery is described in Ullmann's Encyclopedia of Industrial Chemistry, 6th ed. Vol. 11, p. 70 and Vol. 33, pp. 41-81. It is preferable to use mills which have sieve classification, and particularly preferred equipment is fine granulators with sieves and fine granulators with rotors (grater-shredders).

### EXAMPLES

Solids contents were generally determined by drying a defined amount of the aqueous polymer dispersion (about 5 g) at 140° C. in a drying cabinet to constant weight. In each case two separate measurements were carried out. The value stated in each of the examples is the average value from the two measurement results.

The average particle diameter of the copolymer particles was generally determined via dynamic light scattering on an aqueous dispersion of strength of from 0.005 to 0.01% by weight at 23° C. by means of an Autosizer IIC from Malvern Instruments, England. The stated value is the average diameter from cumulative evaluation (cumulant z-average) of the autocorrelation function measured (ISO standard 13321).

### Inventive Example 1

A mixture composed of 323.8 g of deionized water and 2.27 g of a 33% strength by weight aqueous polymer latex (prepared via free-radical-initiated emulsion polymerization of styrene) with a weight-average particle diameter D_{W50} of 30 nm was heated to 80° C. under nitrogen in a 2 l polymerization reactor with blade stirrer and heating/cooling equipment. To this end, 8.06 g of a 7% strength by weight aqueous solution of sodium peroxodisulfate was added at the abovementioned temperature. After 10 min, feed 1 and feed 2 were started. Feed 1 was metered in uniformly over 3 h. Feed 2 was metered in uniformly over 5 h.

Feed 1 was an aqueous emulsion prepared from

| | | |
|---|---|---|
| 191.7 | g | of deionized water |
| 10.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 708.94 | g | of n-butyl acrylate |
| 3.56 | g | of allyl methacrylate |

Feed 2 was divided by 24.2 g of a 7% strength by weight aqueous solution of sodium peroxodisulfate.

Once feed 1 had ended, feed 3 was started after 1 h and metered in uniformly over 1 h.

Feed 3 was an aqueous emulsion prepared from

| | | |
|---|---|---|
| 54.15 | g | of deionized water |
| 5.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 37.5 | g | of methyl methacrylate |

Once feeds 2 and 3 had ended, stirring was continued at 80° C. for a further 0.5 h, and the reaction mixture was then cooled to room temperature.

The resultant aqueous polymer dispersion had a solids content of 52.8% by weight. The average particle size was 303 nm.

### Comparative Example 1

A dispersion was prepared in accordance with the specification of inventive example 1 with the following difference:

Feed 1 was an aqueous emulsion prepared from

| | | |
|---|---|---|
| 125.1 | g | of deionized water |
| 10.0 | g | of a 45% strength by weight aqueous solution of the |
| | | sodium salt of a C₁₂-substituted diphenyl ether sul- |
| | | fonate (Dowfax ® 2A1, trademark of Dow Chemical |
| | | Company) |
| 40.0 | g | of a 3% strength by weight aqueous solution of |
| | | sodium pyrophosphate |
| 608.25 | g | of n-butyl acrylate |
| 3.00 | g | of allyl methacrylate |

Feed 3 was an aqueous emulsion prepared from

| | | |
|---|---|---|
| 54.15 | g | of deionized water |
| 5.0 | g | of a 45% strength by weight aqueous solution of the |
| | | sodium salt of a C₁₂-substituted diphenyl ether sul- |
| | | fonate (Dowfax ® 2A1, trademark of Dow Chemical |
| | | Company) |
| 138.75 | g | of methyl methacrylate |

The resultant aqueous polymer dispersion had a solids content of 53.2% by weight. The average particle size was 305 nm.

### Comparative Example 2

A dispersion was prepared in accordance with the specification of inventive example 1 with the following difference:

Feed 1 was an aqueous emulsion prepared from

| | | |
|---|---|---|
| 191.7 | g | of deionized water |
| 10.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 671.63 | g | of n-butyl acrylate |
| 3.38 | g | of allyl methacrylate |

Feed 3 was an aqueous emulsion prepared from

| | | |
|---|---|---|
| 54.15 | g | of deionized water |
| 5.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 75.0 | g | of methyl methacrylate |

The resultant aqueous polymer dispersion had a solids content of 53.5% by weight. The average particle size was 299 nm.

### Comparative Example 3

A dispersion was prepared in accordance with the specification of inventive example 1 with the following difference:

Feed 1 was an aqueous emulsion prepared from

| | | |
|---|---|---|
| 191.7 | g | of deionized water |
| 10.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 690.28 | g | of n-butyl acrylate |
| 3.47 | g | of allyl methacrylate |

Feed 3 was an aqueous emulsion prepared from

| | | |
|---|---|---|
| 54.15 | g | of deionized water |
| 5.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 56.25 | g | of methyl methacrylate |

The resultant aqueous polymer dispersion had a solids content of 53.6% by weight. The average particle size was 300 nm.

### Comparative Example 4

A dispersion was prepared in accordance with the specification of inventive example 1 with the following difference:

Feed 1 was an aqueous emulsion prepared from

| | | |
|---|---|---|
| 191.7 | g | of deionized water |
| 10.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 727.59 | g | of n-butyl acrylate |
| 3.66 | g | of allyl methacrylate |

Feed 3 was an aqueous emulsion prepared from

| | | |
|---|---|---|
| 54.15 | g | of deionized water |
| 5.0 | g | of a 45% strength by weight aqueous solution of the sodium |
| | | salt of a C₁₂-substituted diphenyl ether sulfonate (Dowfax ® |
| | | 2A1, trademark of Dow Chemical Company) |
| 18.75 | g | of methyl methacrylate |

The resultant aqueous polymer dispersion had a solids content of 53.1% by weight. The average particle size was 291 nm.

### Comparative Example 5

A mixture composed of 323.8 g of deionized water and 2.27 g of a 33% strength by weight aqueous polymer latex (prepared via free-radical-initiated emulsion polymerization of styrene) with a weight-average particle diameter D_{W50} of 30 nm was heated to 80° C. under nitrogen in a 2 l polymerization reactor with blade stirrer and heating/cooling equipment. To this end, 8.06 g of a 7% strength by weight aqueous solution of sodium peroxodisulfate was added at the abovementioned temperature. After 10 min, feed 1 and feed 2 were started. Both feeds were metered in uniformly over 3 h.

Feed 1 was an aqueous emulsion prepared from

| | | |
|---|---|---|
| 245.87 | g | of deionized water |
| 15.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 746.25 | g | of n-butyl acrylate |
| 3.75 | g | of allyl methacrylate |

Feed 2 was divided by 24.2 g of a 7% strength by weight aqueous solution of sodium peroxodisulfate.

Once feeds 1 and 2 had ended, stirring was continued at 80° C. for a further 0.5 h, and the reaction mixture was then cooled to room temperature.

The resultant aqueous polymer dispersion had a solids content of 53.0% by weight. The average particle size was 288 nm.

### Inventive Example 2

A mixture composed of 323.8 g of deionized water and 3.64 g of a 33% strength by weight aqueous polymer latex (prepared via free-radical-initiated emulsion polymerization of styrene) with a weight-average particle diameter D_{W50} of 30 nm was heated to 80° C. under nitrogen in a 2 l polymerization reactor with blade stirrer and heating/cooling equipment. To this end, 8.06 g of a 7% strength by weight aqueous solution of sodium peroxodisulfate was added at the abovementioned temperature. After 10 min, feed 1 and feed 2 were started. Feed 1 was metered in uniformly over 3 h. Feed 2 was metered in uniformly over 5 h.

Feed 1 was an aqueous emulsion prepared from

| | | |
|---|---|---|
| 191.2 | g | of deionized water |
| 10.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 709.83 | g | of n-butyl acrylate |
| 2.67 | g | of allyl methacrylate |

Feed 2 was divided by 24.2 g of a 7% strength by weight aqueous solution of sodium peroxodisulfate.

Once feed 1 had ended, feed 3 was started after 1 h and metered in uniformly over 1 h.

Feed 3 was an aqueous emulsion prepared from

| | | |
|---|---|---|
| 54.15 | g | of deionized water |
| 5.0 | g | of a 45% strength by weight aqueous solution of the sodium |
| | | salt of a C₁₂-substituted diphenyl ether sulfonate (Dowfax ® |
| | | 2A1, trademark of Dow Chemical Company) |
| 37.5 | g | of methyl methacrylate |

Once feeds 2 and 3 had ended, stirring was continued at 80° C. for a further 0.5 h, and the reaction mixture was then cooled to room temperature.

The resultant aqueous polymer dispersion had a solids content of 53.5% by weight. The average particle size was 266 nm.

### Comparative Example 6

A dispersion was prepared in accordance with the specification of inventive example 2 with the following difference:

Feed 1 was an aqueous emulsion prepared from

| | | |
|---|---|---|
| 191.7 | g | of deionized water |
| 10.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 672.47 | g | of n-butyl acrylate |
| 2.53 | g | of allyl methacrylate |

Feed 3 was an aqueous emulsion prepared from

| | | |
|---|---|---|
| 54.15 | g | of deionized water |
| 5.0 | g | of a 45% strength by weight aqueous solution of the sodium |
| | | salt of a C₁₂-substituted diphenyl ether sulfonate (Dowfax ® |
| | | 2A1, trademark of Dow Chemical Company) |
| 75.0 | g | of methyl methacrylate |

The resultant aqueous polymer dispersion had a solids content of 53.6% by weight. The average particle size was 264 nm.

### Comparative Example 7

A dispersion was prepared in accordance with the specification of inventive example 2 with the following difference:

Feed 1 was an aqueous emulsion prepared from

| | | |
|---|---|---|
| 191.7 | g | of deionized water |
| 10.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 691.13 | g | of n-butyl acrylate |
| 2.63 | g | of allyl methacrylate |

Feed 3 was an aqueous emulsion prepared from

| | | |
|---|---|---|
| 54.15 | g | of deionized water |
| 5.0 | g | of a 45% strength by weight aqueous solution of the sodium |
| | | salt of a C₁₂-substituted diphenyl ether sulfonate (Dowfax ® |
| | | 2A1, trademark of Dow Chemical Company) |
| 56.25 | g | of methyl methacrylate |

The resultant aqueous polymer dispersion had a solids content of 53.5% by weight. The average particle size was 260 nm.

### Comparative Example 8

A dispersion was prepared in accordance with the specification of inventive example 2 with the following difference:

Feed 1 was an aqueous emulsion prepared from

| | | |
|---|---|---|
| 191.7 | g | of deionized water |
| 10.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 728.51 | g | of n-butyl acrylate |
| 2.74 | g | of allyl methacrylate |

Feed 3 was an aqueous emulsion prepared from

| | | |
|---|---|---|
| 54.15 | g | of deionized water |
| 5.0 | g | of a 45% strength by weight aqueous solution of the sodium |
| | | salt of a C₁₂-substituted diphenyl ether sulfonate (Dowfax ® |
| | | 2A1, trademark of Dow Chemical Company) |
| 18.75 | g | of methyl methacrylate |

The resultant aqueous polymer dispersion had a solids content of 53.8% by weight. The average particle size was 262 nm.

### Comparative Example 9

A mixture composed of 323.8 g of deionized water and 3.64 g of a 33% strength by weight aqueous polymer latex (prepared via free-radical-initiated emulsion polymerization of styrene) with a weight-average particle diameter D_{W50} of 30 nm was heated to 80° C. under nitrogen in a 2 l polymerization reactor with blade stirrer and heating/cooling equipment. To this end, 8.06 g of a 7% strength by weight aqueous solution of sodium peroxodisulfate was added at the abovementioned temperature. After 10 min, feed 1 and feed 2 were started. Both feeds were metered in uniformly over 3 h.

Feed 1 was an aqueous emulsion prepared from

| | | |
|---|---|---|
| 245.34 | g | of deionized water |
| 15.0 | g | of a 45% strength by weight aqueous solution of the |
| | | sodium salt of a C₁₂-substituted diphenyl ether |
| | | sulfonate (Dowfax ® 2A1, trademark of Dow Chemical |
| | | Company) |
| 40.0 | g | of a 3% strength by weight aqueous solution of sodium |
| | | pyrophosphate |
| 747.19 | g | of n-butyl acrylate |
| 2.81 | g | of allyl methacrylate |

Feed 2 was divided by 24.2 g of a 7% strength by weight aqueous solution of sodium peroxodisulfate.

Once feeds 1 and 2 had ended, stirring was continued at 80° C. for a further 0.5 h, and the reaction mixture was then cooled to room temperature.

The resultant aqueous polymer dispersion had a solids content of 53.3% by weight. The average particle size was 260 nm.

### Determination of Impact Resistance of PVC Moldings

A mixture composed of

100 parts of PVC powder (Solvin 265 RE, Solvay)
7 parts of Pb stabilizer (Baeropan R 2930 SP 1, Baerlocher)
6 parts of CaCO₃ (Hydrocarb 95 T, Omya), and
4 parts of TiO₂ (Kronos 2220, Kronos International)
together with 7 parts (based on solids content) of the polymer dispersions of inventive examples 1 and 2 and of comparative examples 1 to 9 was charged to a roll (110P two-roll mill from Collin GmbH), and a milled sheet was produced by roll-milling at 180° C. for 8 min. This was pressed at 190° C. for 8 min at 15 bar and then for 5 min at 200 bar to give a pressed sheet, which was cooled at 200 bar over 8 min. Test specimens were sawn out from the pressed sheet and then notched. Notched impact resistances were determined by the Charpy method based on DIN 53753. Test specimens of thickness 3 mm were used and were double-V-notched with notch radius 0.1 mm. A Zwick (B5102E) pendulum impact tester was used for the test, the nominal value for the energy available from the pendulum being 1 J. The average value was calculated from ten individual measurements.

TABLE 1

| | | | Content of | |
|---|---|---|---|---|
| | | | crosslinking | |
| | Content of | | agent in core | Notched impact |
| | shell in % | Particle | (% by | resistance |
| | by weight | size | weight) | [kJ/m²] |
| Inventive | 5 | 303 nm | 0.5% | 52.4 |
| example 1 | | | | |
| Inventive | 5 | 266 nm | 0.38% | 53 |
| example 2 | | | | |
| Comparative | 18.5 | 305 nm | 0.5% | 40.4 |
| example 1 | | | | |
| Comparative | 10 | 299 nm | 0.5% | 49 |
| example 2 | | | | |
| Comparative | 7.5 | 300 nm | 0.5% | 51 |
| example 3 | | | | |
| Comparative | 2.5 | 291 nm | 0.5% | 50.2 |
| example 4 | | | | |
| Comparative | 0 | 288 nm | 0.5% | 42.7 |
| example 5 | | | | |
| Comparative | 10 | 264 nm | 0.38% | 50 |
| example 6 | | | | |
| Comparative | 7.5 | 260 nm | 0.38% | 49 |
| example 7 | | | | |
| Comparative | 2.5 | 262 nm | 0.38% | 46.7 |
| example 8 | | | | |
| Comparative | 0 | 260 nm | 0.38% | 45.4 |
| example 9 | | | | |

### Spray Drying

A polymer dispersion according to inventive example 1 was spray-dried. The spray drying took place in a spray tower with 1.0 mm single-fluid-nozzle atomization at 45 bar using the straight-through N₂ method with tower inlet temperature of 135° C. and outlet temperature of 58° C. 4.0% by weight (based on the solids content of the dispersion) of stearic acid-coated calcium carbonate (Winnofil S from Solvay) were metered continuously into the head of the spray tower by way of a weight-controlled twin screw simultaneously with the polymer dispersion.

### Powder Properties

Grain Size

Volume-average particle size d₅₀ was measured with a Malvern Mastersizer 2000/Hydro 2000 G.

Bulk Density

Bulk density was determined to EN ISO 60.

Flowability

Flowability determination was based on DIN EN ISO 2431. A DIN 53 211 flow cup with 6 mm nozzle was used here.

Caking

Tendency toward caking was measured by charging 200 g of the test powder by way of a 1000 μm sieve into a plastics pipe (internal diameter 100 mm, height 160 mm) standing in a Petri dish (diameter 120 mm). A circular plastics sheet (diameter 98 mm) and a weight (brass) of 15 kg were placed on the charge of powder. After a residence time of 2 h at 22° C., the weights were removed and the pressed powder was carefully transferred to a 2000 μm sieve in a (Fritsch analysette 3Pro) sieve shaker machine. The sieve stack was closed and the specimen was sieved at amplitude 0.4 mm. The time needed for all of the powder to fall through the sieve was measured.

### Inventive Example 3

The polymer powder obtained from the spray-drying process was sheared by means of a rotor-based fine granulator (RFG 150 from Alexanderwerk) with 0.5 mm sieve insert.

### Inventive Example 4

The polymer powder obtained from the spray-drying process was sheared by means of a rotor-based fine granulator (RFG 150 from Alexanderwerk) with 0.63 mm sieve insert.

### Inventive Example 5

The polymer powder obtained from inventive example 4 was sheared by means of a rotor-based fine granulator (RFG 150 from Alexanderwerk) with 0.5 mm sieve insert.

### Inventive Example 6

The polymer powder obtained from the spray-drying process was sheared at 700 rpm by means of a grater-shredder (R165N from Alexanderwerk) with 0.3 mm sieve insert.

### Inventive Example 7

The polymer powder obtained from the spray-drying process was sheared at 700 rpm by means of a grater-shredder (R165N from Alexanderwerk) with 0.63 mm sieve insert.

### Inventive Example 8

The polymer powder obtained from the spray-drying process was sheared at 330 rpm by means of a grater-shredder (R300N from Alexanderwerk) with 0.3 mm sieve insert.

### Comparative Example 10

The polymer powder obtained from the spray-drying process was used directly.

TABLE 2

| | Grain size | | | | |
|---|---|---|---|---|---|
| | d₅₀ | Bulk density | Flowability | Caking | |
| Inventive example 3 | 275 μm | 0.32 g/ml | 0.97 g/s | 7 | s |
| Inventive example 4 | 240 μm | 0.31 g/ml | 0.96 g/s | 7 | s |
| Inventive example 5 | 233 μm | 0.35 g/ml | 1.24 g/s | 4 | s |
| Inventive example 6 | 222 μm | 0.39 g/ml | 1.18 g/s | 30 | s |
| Inventive example 7 | 257 μm | 0.39 g/ml | 1.46 g/s | 35 | s |
| Inventive example 8 | 197 μm | 0.43 g/ml | 1.60 g/s | 42 | s |
| Comparative | 349 μm | 0.24 g/ml | 0.79 g/s | 38 | s |
| example 10 | | | | | |

1. A process for production of polymer powder from an aqueous polymer dispersion, which comprises obtaining the aqueous dispersion of the polymer particles II via free-radical-initiated aqueous emulsion polymerization of at least one ethylenically unsaturated monomer C in the presence of dispersely distributed polymer particles I, where
a) the polymer of the at least one unsaturated monomer C has a glass transition temperature >60° C.,
b) the dispersely distributed polymer particles I are obtained via free-radical-initiated aqueous emulsion polymerization of a monomer mixture I, comprising

| | |
|---|---|
| from 98.0 to 99.9% by weight | of at least one ethylenically unsaturated |
| | monomer A whose polymer has a glass |
| | transition temperature <−20° C., and |
| from 0.1 to 2.0% by weight | of at least one compound (monomer B) |
| | having crosslinking action and having at |
| | least two non-conjugated vinyl groups, |

c) the quantitative ratio of monomer mixture I to monomer C is >90% by weight: <10% by weight, where the total amounts of monomer mixture I and monomer C give a total of 100% by weight,
d) the powder is produced from the aqueous dispersion of polymer particles II
i. via spray drying in the presence of from 0.1 to 15% by weight of at least one antiblocking agent, based on the total weight of polymer particles II, and subsequent comminution of the crude powder by means of mechanically and/or pneumatically induced shear forces, or
ii. via mechanical and/or pneumatic grinder drying in the presence of from 0.1 to 15% by weight of at least one antiblocking agent, based on the total amount of polymer particles II.

2. The process according to claim 1, wherein a sieve-based fine granulator, a rotor-based fine granulator or a fluidizer mill is used to comminute the crude powder.

3. The process according to claim 1, wherein a fluidizer mill is used for the grinder-drying process.

4. The process according to claim 1, wherein the polymer particles II have a multimodal particle size distribution, and comprise at least two particle populations which have the same or different chemical constitutions, whose average particle diameters differ from one another by at least 30 nm, where the content of the particle population with the largest average particle diameter is at least 15% by weight and the content of the particle population with the smallest average particle diameter is at least 5% by weight.

5. The process according to claim 1, wherein, prior to the spray-drying process, polymer particles III obtained via free-radical-initiated aqueous emulsion polymerization of at least one ethylenically unsaturated monomer D are added to the aqueous dispersion of the polymer particles II, where
a. the polymer of the at least one unsaturated monomer D has a glass transition temperature >50° C.,
b. the content of the polymer particles III, based on the amount of polymer particles II, is >5% by weight and <30% by weight,
c. the at least one monomer D has been selected from the group of the C₁-C₈-alkyl acrylates, C₁-C₄-alkyl methacrylates, styrene, acrylonitrile, methacrylic acid, acrylic acid, or of the compounds having crosslinking action and having at least two non-conjugated vinyl groups, or from mixtures of these.

6. The process according to claim 1, wherein the quantitative ratio of monomer mixture I to monomer C is from ≧93% by weight:<7% by weight to <97% by weight:>3% by weight.

7. The process according to claim 1, wherein
a. from 95 to 100% by weight of the monomers A have been selected from the group of the C₁-C₈-alkyl acrylates, butadiene, or from mixtures of these,
b. the monomer B has been selected from the group of allyl methacrylate, butanediol dimethacrylate, or dihydrodicyclopentadienyl acrylate,
c. from 90 to 100% by weight of the monomers C have been selected from the group of the C₁-C₄-alkyl methacrylates, the C₁-C₈-alkyl acrylates, vinyl chloride, styrene, acrylonitrile, or from mixtures of these.

8. The process according to claim 1, wherein the monomer A used comprises n-butyl acrylate and/or 2-ethylhexyl acrylate, the monomer B used comprises allyl methacrylate, and the monomer C used comprises methyl methacrylate.

9. The process according to claim 1, wherein the antiblocking agent has a primary particle size <100 nm.

10. The process according to claim 1, wherein the antiblocking agent used comprises stearic acid-coated calcium carbonate.

11. A polymer powder obtainable by a process according to claim 1.

12. A modified polyvinyl chloride (PVC) wherein the polymer powder according to claim 11 is used.

13. A PVC composition comprising from 0.1 to 50% by weight of polymer powder according to claim 11 homogeneously distributed.

14. (canceled)

15. A molding produced using PVC compositions according to claim 13.
